(19) United States
(12) Patent Application Publication
(10) Pub. No.: US 2026/0178404 A1
(43) Pub. Date: Jun. 25, 2026

(54) PULSE-BASED CLOUD MANAGEMENT SWITCHING AND RESOLUTION

(71) Applicant: Kyndryl, Inc., New York, NY (US)

(72) Inventors: Kalpesh Sharma, Bangalore (IN); Nalini M, Chennai (IN); Veeresh Bushetti, Bengaluru (IN)

(21) Appl. No.: 18/986,899

(22) Filed: Dec. 19, 2024

(51) Int. Cl. G06F 9/50; G06F 11/34

(52) U.S. Cl. CPC G06F 9/5044; G06F 9/5083; G06F 11/3409

(57) ABSTRACT

A computer-implemented method for receiving a first set of resource allocation data related to a first set of SRE tools and predicting a first state of a cloud environment based on the first set of resource allocation data. The method further includes switching the cloud environment to a second set of SRE tools based on the first state of the cloud environment. In embodiments, the method further includes receiving a second set of resource allocation data related to the second set of SRE tools and predicting a second state of the cloud environment based on the second set of resource allocation data. In embodiments, the method also includes switching the cloud environment to the first set of SRE tools based on the second state of the cloud environment.

### BACKGROUND

Aspects of the present invention relate generally to cloud monitoring and data management.

Site reliability engineering (SRE) tools (e.g., cloud monitoring tools) provide continuous oversight of site and cloud-based systems, applications, and services to ensure efficient, secure, and reliable operations. These tools collect and analyze data on resource usage, system performance metrics, and security-related events.

### SUMMARY

In a first aspect of the present invention, there is a computer-implemented method including: receiving, by a processor set, a first set of resource allocation data related to a first set of site reliability engineering (SRE) tools; predicting, by the processor set, a first state of a cloud environment based on the first set of resource allocation data, wherein the first state and the first set of resource allocation data describe a stable cloud environment; switching, by the processor set, the cloud environment to a second set of SRE tools based on the first state of the cloud environment wherein the second set of SRE tools are selected for monitoring the stable cloud environment; receiving, by the processor set, a second set of resource allocation data related to the second set of SRE tools; predicting, by the processor set, a second state of the cloud environment based on the second set of resource allocation data, wherein the second state and the second set of resource allocation data describe a volatile cloud environment; and switching, by the processor set, the cloud environment to the first set of SRE tools based on the second state of the cloud environment, wherein the first set of SRE tools are selected for monitoring the volatile cloud environment.

In another aspect of the present invention, there is a computer program product including one or more computer readable storage media having program instructions collectively stored on the one or more computer readable storage media. The program instructions are executable to: receive a first set of resource allocation data related to a first set of site reliability engineering (SRE) tools; predict a first state of a cloud environment based on the first set of resource allocation data, wherein the first state and the first set of resource allocation data describe a stable cloud environment; switch the cloud environment to a second set of SRE tools based on the first state of the cloud environment, wherein the second set of SRE tools are selected for monitoring the stable cloud environment; receive a second set of resource allocation data related to the second set of SRE tools; predict a second state of the cloud environment based on the second set of resource allocation data, wherein the second state and the second set of resource allocation data describe a volatile cloud environment; and switch the cloud environment to the first set of SRE tools based on the second state of the cloud environment, wherein the first set of SRE tools are selected for monitoring the volatile cloud environment.

In another aspect of the present invention, there is a system including a processor, a computer readable memory, one or more computer readable storage media, and program instructions collectively stored on the one or more computer readable storage media. The program instructions are executable to: receive a first set of resource allocation data related to a first set of site reliability engineering (SRE) tools; predict a first state of a cloud environment based on the first set of resource allocation data, wherein the first state and the first set of resource allocation data describe a stable cloud environment; switch the cloud environment to a second set of SRE tools based on the first state of the cloud environment, wherein the second set of SRE tools are selected for monitoring the stable cloud environment; receive a second set of resource allocation data related to the second set of SRE tools; predict a second state of the cloud environment based on the second set of resource allocation data, wherein the second state and the second set of resource allocation data describe a volatile cloud environment; and switch the cloud environment to the first set of SRE tools based on the second state of the cloud environment, wherein the first set of SRE tools are selected for monitoring the volatile cloud environment.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a cloud computing node according to an embodiment of the present invention.

FIG. 2 depicts a cloud computing environment according to an embodiment of the present invention.

FIG. 3 depicts abstraction model layers according to an embodiment of the present invention.

FIG. 4 shows a block diagram of an exemplary environment in accordance with aspects of the present invention.

FIG. 5 shows a flow chart of an exemplary method in accordance with aspects of the present invention.

FIG. 6 shows a flow diagram of an exemplary method in accordance with aspects of the present invention.

FIGS. 7A-7B show a block diagram of an exemplary environment in accordance with aspects of the present invention.

FIG. 8 shows an exemplary sine wave in accordance with aspects of the present invention.

FIG. 9 shows an exemplary calculation table in accordance with aspects of the present invention.

FIG. 10 shows a flow diagram of an exemplary method in accordance with aspects of the present invention.

### DETAILED DESCRIPTION

Aspects of the present invention relate generally to cloud monitoring and data management. According to aspects of the present invention, the system, method, and computer program product may be configured to make cloud monitoring tool decisions based on a current or a predictive pulse of the system.

According to an aspect of the present invention, there is a computer-implemented method for optimizing cloud resource utilization, the method includes receiving a first set of resource allocation data, the first set having been generated using a set of premium site reliability engineering (SRE) tools (e.g., monitoring tools); predicting, based on the first set, a first state of an oscillating cloud environment; determining, based on the first state, to switch to a set of non-premium SRE tools; receiving a second set of resource allocation data from the set of non-premium SRE tools; predicting, based on the second set, a second state of an oscillating cloud environment; determining, based on the second state, to switch to the set of premium SRE tools; and providing a report describing the first and second states and the predictions based on the first and second sets of resource allocation data.

According to an aspect of the present invention, the foregoing prediction is based on the second set and may determine that the set of premium SRE tools meets a resource performance threshold. According to an aspect of the present invention, the foregoing prediction is based on the first set and may determine that the set of non-premium SRE tools meets a second resource performance threshold.

According to an aspect of the present invention, the foregoing method for optimizing cloud resource utilization may further include receiving a third set of resource allocation data, the third set having been generated by either the set of premium or set of non-premium SRE tools; predicting, based on the third set, a third state of an oscillating cloud environment; and determining, based on the third state, to switch to a hybrid set of SRE tools, the hybrid set including a subset of the set of premium SRE tools and a subset of the set of non-premium SRE tools.

According to an aspect of the present invention the foregoing first, second, and third states may be mapped to a pulse packet sine curve, a first, second, and third integral of the pulse packet sine curve correlating to the first, second, and third states of the oscillating cloud environment.

Conventional cloud setup and monitoring technologies are stagnant and rely heavily on fixed tools, including high-cost premium options that lead to inefficient resource utilization and an unnecessary expenditure. In existing technology, monitoring tool decisions are generally static in nature and lead to unnecessary costs when premium options are enabled in a stable environment. However, not all conventional tools are necessary at all times. In particular, not all conventional tools are necessary in environments that tend to be stable (non-volatile). However, even relatively stable environments may encounter periods of time where the more premium tool options are desirable or necessary to safeguard an application and/or an infrastructure. Conventional technologies lack fluidity and flexibility to adjust to changing needs. In other words, conventional systems employ premium options at premium costs in response to non-premium tools being adequate for most tasks. For example, in response to conventional systems employing non-premium options, the related applications and infrastructure are vulnerable to failure. Accordingly, a more intelligent approach is necessary in which cloud monitoring tool decisions are dynamically made based on a current or a predictive pulse of the system.

As used in the embodiments, the term pulse refers to a regular, systematic signal or data transmission that allows the management server to monitor the health, performance, and status of various managed resources, applications, and services within a cloud environment. In embodiments, the pulse may include sending periodic updates or signals (i.e., pulse packets) from managed resources (e.g., servers, applications, containers, etc.) to a management server. In such embodiments, these pulses provide real-time and/or historical information about the current state, performance metrics, and operational status of the resources. In embodiments, the pulse may also, or alternatively, include sending configuration states or compliance status reports to ensure that resources adhere to predefined policies and standards. In embodiments, the pulse may also, or alternatively, include data on user activity, load conditions, and resource utilization patterns. In embodiments, the pulse may also, or alternatively, include necessary data for automated processes such as scaling resources up or down based on real-time demand. In further embodiments, the pulse may also, or alternatively, serve as a communication mechanism between various components of a cloud infrastructure. In aspects of the present invention, the pulse comprises a non-transitory signal.

According to aspects of the present invention, dynamically making cloud monitoring tool decisions based on a current or a predictive pulse of the system ensures optimal resource allocation and enhances system resilience and empowers developers to deliver expedited resolution effectively. Embodiments and aspects of the present invention provide a system, a method, and a computer program product that improves and advances the technology in a specific and practical application. In other words, embodiments and aspects of the present invention improve the field of cloud monitoring and data management by providing a more intelligent approach for making cloud monitoring tool decisions and dynamically adjusting (e.g., switching) the site reliability engineering (SRE) tools (e.g., monitoring tools) based on a current (or a predictive) pulse of the system.

Implementations of the present invention are necessarily rooted in computer technology. For example, at least the steps of receiving a first set of resource allocation data related to a first set of SRE tools; predicting a first state of a cloud environment based on the first set of resource allocation data; and switching the cloud environment to a second set of SRE tools based on the first state of the cloud environment, are computer-based, are individually and collectively complex, and cannot be performed in the human mind. Given the scale and complexity required to perform the foregoing tasks, it is simply not possible for the human mind, or for a person using pen and paper, to perform the number of calculations involved in: using a random forest machine learning model and/or a decision tree machine learning model to facilitate and/or perform pulse packet labeling and/or assigning the pulse packet data to an appropriate condenser; using a reinforcement learning machine learning model to detect and carry out real-time updates on Day1 and Day2 Development Operations (DevOps) tools (DDT tools) and to update the pulse based on the updated DDT tools; and using natural language processing (NLP) models to perform various data analyses, the NLPs comprising text classification models (e.g., Bidirectional Encoder Representations from Transformers (BERT), Robustly Optimized BERT Pretraining Approach (ROBERTa), and/or Generative Pre-trained Transformer (GPT)), entity recognition and abnormality detection models (e.g., named entity recognition (NER)), computer vision integration models (e.g., optical character recognition and/or image segmentation), etc.

It should be understood that, to the extent implementations of the present invention collect, store, or employ personal information provided by, or obtained from, individuals (for example, any customer content and/or customer data that may include personal information, personal communications, personal preferences, identifying information, etc.), such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium or media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

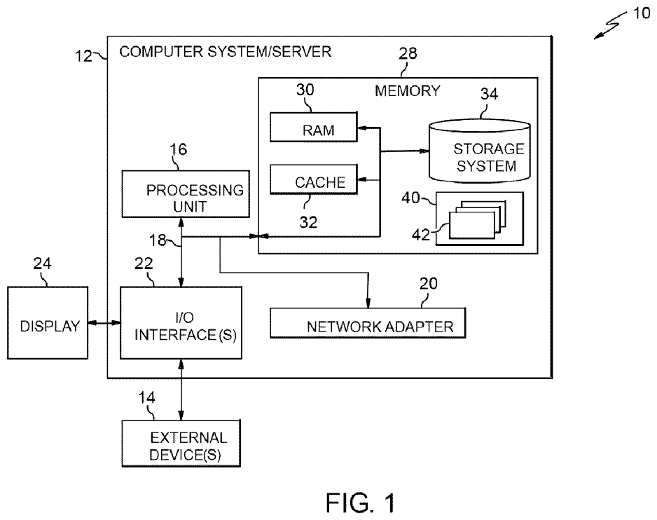

Referring now to FIG. 1, a schematic of an example of a cloud computing node is shown. Cloud computing node 10 is only one example of a suitable cloud computing node and is not intended to suggest any limitation as to the scope of use or functionality of embodiments of the present invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random-access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the present invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the present invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to microcode, device drivers, redundant processing units, external disk drive arrays, RAID systems, tape drives, and data archival storage systems, etc.

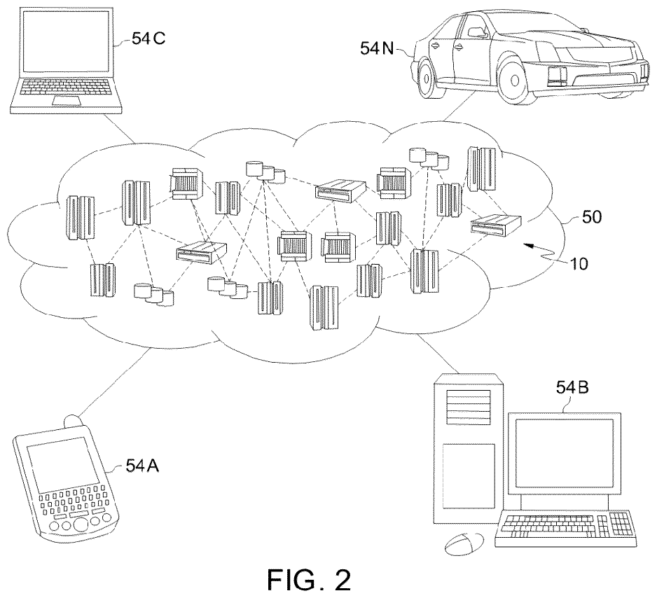

Referring now to FIG. 2, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

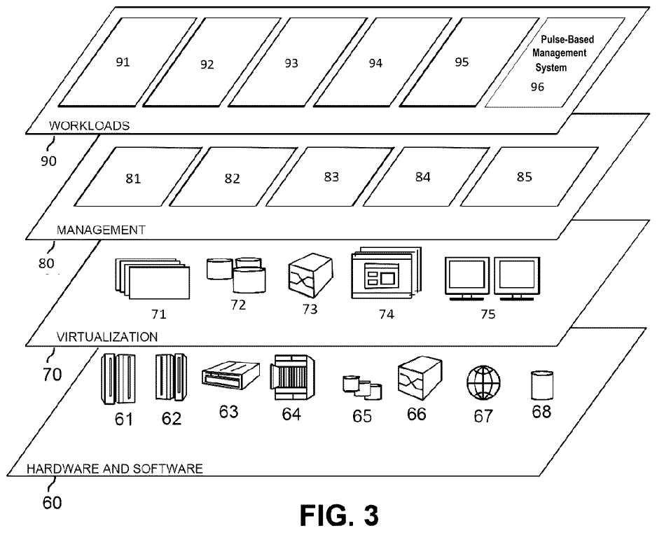

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the present invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and pulse-based management system 96.

Implementations of the present invention may include a computer system/server 12 of FIG. 1 in which one or more of the program modules 42 are configured to perform (or cause the computer system/server 12 to perform) one of more functions of pulse-based management system 96 of FIG. 3. For example, the one or more of the program modules 42 may be configured to: receive a first set of resource allocation data related to a first set of site reliability engineering (SRE) tools (e.g., monitoring tools); predict a first state of a cloud environment based on the first set of resource allocation data; switch the cloud environment to a second set of SRE tools based on the first state of the cloud environment; receive a second set of resource allocation data related to the second set of SRE tools; predict a second state of the cloud environment based on the second set of resource allocation data; and switch the cloud environment to the first set of SRE tools based on the second state of the cloud environment.

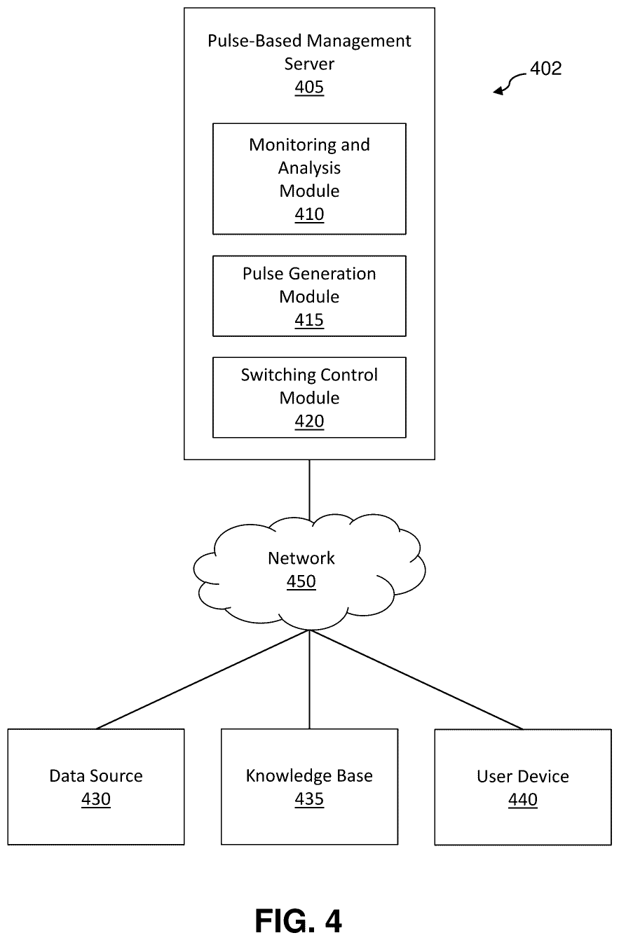

FIG. 4 shows a block diagram of exemplary environment 402 in accordance with aspects of the present invention. In embodiments, the environment 402 includes pulse-based management server 405, data source 430, a knowledge base 435, user device 440, and a network 450.

Pulse-based management server 405 may comprise one or more instances of computer system/server 12 of FIG. 1. In another example, pulse-based management server 405 may comprise one or more virtual machines or containers running on one or more instances of computer system/server 12 of FIG. 1. In embodiments, pulse-based management server 405 communicates with data source 430, knowledge base 435, and user device 440 via network 450, which may comprise cloud computing environment 50 of FIG. 2. In embodiments, data source 430 comprises one or more instances of hardware and software components of hardware and software layer 60 of FIG. 3. In embodiments, knowledge base 435 comprises one or more instances of hardware and software layer 60 of FIG. 3. In embodiments, knowledge base 435 comprises a corpus of data (i.e., a collection of data) used to train and evaluate machine learning models. In embodiments, user device 440 comprises an instance of an end user device such as, for example, personal digital assistant (PDA) or cellular telephone 54A, desktop computer 54B, laptop computer 54C, and/or automobile computer system 54N of FIG. 2. In embodiments, there may be plural different instances of user device 440. The different instances of user device 440 may be used by different users, product managers, system administrators, and/or other users that may access pulse-based management server 405, respectively.

In embodiments, pulse-based management server 405 comprises monitoring and analysis module 410, pulse generation module 415, and switching control module 420, each of which may comprise one or more program modules such as program modules 42 described with respect to FIG. 1. Pulse-based management server 405 may include additional or fewer modules than those shown in FIG. 4. In embodiments, separate modules may be integrated into a single module. Additionally, or alternatively, a single module may be implemented as multiple modules. Moreover, the quantity of devices and/or networks in the environment is not limited to what is shown in FIG. 4. In practice, the environment may include additional devices and/or networks; fewer devices and/or networks; different devices and/or networks; or differently arranged devices and/or networks than illustrated in FIG. 4.

In accordance with aspects of the present invention, monitoring and analysis module 410 is configured to obtain and/or receive, monitor, and analyze resource allocation data related to site reliability engineering (SRE) tools (e.g., monitoring tools) used in one or more applications operating within a cloud management system. In other words, monitoring and analysis module 410 monitors and analyzes cloud management applications using a variety of tools and techniques to ensure optimal performance, security, and efficiency. As used herein, monitoring involves real-time tracking of resources, services, and applications hosted in the cloud. In embodiments, components like virtual machines, containers, databases, storage, and network usage are continuously observed. In embodiments, monitoring and analysis module 410 may monitor and track metrics like resource utilization (e.g., CPU, memory, storage), response times, error rates, and throughput to ensure that the cloud infrastructure is operating efficiently.

In embodiments, the monitoring and analysis module 410 may analyze cloud management metrics, which may include deeper insights into usage patterns, costs, and performance trends. In further embodiments, the monitoring and analysis module 410 may include assessing operational health by reviewing logs, identifying bottlenecks, and predicting future needs with capacity planning. In embodiments, monitoring and analysis module 410 may track security metrics which include tracking unauthorized access attempts, firewall breaches, compliance violations, etc. In further embodiments, monitoring and analysis module 410 may track cost analyses, including monitoring billing data, analyzing resource usage, identifying opportunities for optimization by eliminating idle resources or reallocating workloads, and more. In aspects of the present invention, the monitoring and analysis efforts of monitoring and analysis module 410 seeks to ensure that cloud applications and environments are both cost-effective and resilient.

In embodiments, monitoring and analysis module 410 is further configured to obtain, receive, monitor, and/or analyze resource allocation data related to Day1 and Day2 Development Operations (DevOps) (DDD) SRE tools. In the cloud management, DDD tools help organize services, systems, and architectures around business domains and their specific needs. As used herein, Day 1 DevOps (DDD) SRE tools focus on setting up the infrastructure, deploying applications, and establishing automated processes for building and testing. Day 2 DevOps (DDD) SRE tools involve ongoing management, monitoring, scaling, and optimization to ensure stability, security, and performance in production. DDD SRE tools may include tools designed for: performance monitoring (e.g., real-time application monitoring, CPU utilization, memory utilization, network latency, throughput, etc.), security assessment (cloud security posture management, container and application scanning, web application firewall, threat intelligence, etc.), configuration management (e.g., infrastructure as code, configurations in cloud-native services, etc.), log management (e.g., centralized log collection, distributed tracing, log aggregation, etc.), capacity planning (e.g., web application scaling, database provisioning, serverless function management, etc.), backup and recovery (e.g., snapshot backups, object storage backups, database backups, etc.), compliance and auditing (i.e., ensuring that applications meet regulatory requirements and maintain security standards), service management (e.g., service management, change management, service-level management, etc.), end-user experience monitoring (e.g., real-user monitoring, synthetic monitoring, application performance monitoring, etc.), asset management (e.g., cloud resource inventory management, cost management and optimization, compliance management, etc.), network analysis and diagnosis, etc.

In further embodiments, monitoring and analysis module 410 is further configured to monitor and analyze application deployment patterns (e.g., blue-green deployment, canary deployment, rolling deployment, etc.), application infrastructure (e.g., container orchestration, Kubernetes, serverless computing, content delivery network, etc.), an application current load (e.g., CPU utilization, memory utilization, request rate, database connection pool usage, etc.), a minimum and/or maximum load capacity, number of active users on an application, vulnerability exposure and security issues (cloud security posture management, container and application scanning, web application firewall, threat intelligence, etc.), replicas and states (e.g., Kubernetes, auto scaling groups, various application services, etc.). In such embodiments, monitoring and analysis module 410 performs monitoring and analyzing with the aid of, web and/or mobile applications, application program interface (API) services, data services, middleware services, infrastructure services, etc.

In accordance with aspects of the present invention, the pulse generation module 415 is configured to predict a state of a cloud environment based on the resource allocation data monitored, analyzed, received, and/or obtained by the monitoring and analysis module 410. In other words, the pulse generation module 415 may use data from the monitoring and analysis module 410 to determine, define, and/or generate a pulse of the system (e.g., application health data). In embodiments, the term pulse refers to a regular, systematic signal or data transmission that allows the management server to monitor the health, performance, and status of various managed resources, applications, and services within a cloud environment. In further embodiments, the pulse may include sending periodic updates or signals (i.e., pulse packets) from managed resources (e.g., servers, applications, containers, etc.) to a management server (such as pulse-based management server 405). In such embodiments, these pulses provide real-time and/or historical information about the current state, performance metrics, and operational status of the resources. In further embodiments, the pulse may also include sending configuration states or compliance status reports to ensure that resources adhere to predefined policies and standards. In embodiments, the pulse may also include data on user activity, load conditions, and resource utilization patterns. In further embodiments, the pulse may also include necessary data for automated processes such as scaling resources up or down based on real-time demand. In embodiments, the pulse may also serve as a communication mechanism between various components of a cloud infrastructure. In aspects of the present invention, the pulse comprises a non-transitory signal.

Accordingly, in embodiments, the pulse generation module 415 determines and/or generates a pulse. In further embodiments, the pulse generation module 415 is configured to predict the state of a cloud environment based on the resource allocation data monitored, analyzed, received, and/or obtained by the monitoring and analysis module 410.

In embodiments, the pulse generation module 415 is configured to assign the resource allocation data to one or more condensers and determine a score for each condenser based on the quality, or lack of quality, of data related to the condenser. In aspects of the present invention,
a condenser comprises a component and/or service for storing aggregated, processed, and/or optimized pulse packet data collected from various monitored resources within a cloud environment (e.g., data monitored, analyzed, received, and/or obtained by the monitoring and analysis module 410 that is included in a pulse).

In embodiments, condensers may include:
Deployment condenser—storing data such as frequency, success rate, change failure rate, lead time, deployment time, rollback time, uptime, availability, error rates, user impact, mean time to repair (MTTR), and more.
Infrastructure condenser—storing data such as CPU usage, memory usage, disk input/output, network throughput, latency, error rate, request rate, data base performance, cache performance, service health, load balancing, health logs, security metrics, and more.
User Condenser—storing data such as user engagement, retention, conversion rate, error rate, response time, user feedback, feature usage, crash analysis, user-journey analysis, synthetic live experience, and more.
Vulnerability condenser—storing data such as number of vulnerabilities, severity, time to detect, time to remediate, reoccurrence rate, density, patch management, exploitable rate, impact metrics, compliance metrics, and more.
Security condenser—storing data such as mean time to detect, mean time to respond, alert volume, triage rate, closure rate, unauthorized access attempt, authentication success rate, compliance and audit finding, phishing and social engineering metrics, and more.
Automation condenser—storing data such as time saved, error reduction, cycle time reduction, resource utilization, process compliance, throughput and scalability, customer satisfaction, return of investment, operational visibility, and more.
Testing condenser—storing data such as test coverage, detect density, environment stability, stability, resource utilization, throughput, stability, and more.
Functionality condenser—storing data such as comprehensive monitoring data, real-time monitoring data, historical analysis, version control automation log ingestion rate, query language, real-time search, and more.
Scalability condenser—storing data such as capacity, elasticity, data handling, and more.
Ease of Use condenser—storing data such as user interface setup, configurations, reporting, deployment, management and maintenance learning curve, and more.
Alerts/Detection condenser—storing data such as customizable alerts, multichannel notification, escalation policies, alert prioritization, threat detection, zero-day detection, alerts accuracy, and more.
Security condenser—storing data such as data security, access controls, compliance, threat intelligence, encryption, and more.
Cost condenser—storing data such as total-cost ownership, maintenance cost, pricing model, cost efficiency, value for the money enterprise support, initial cost, scalability of cost, operational cost, flexibility and customization cost, hidden cost, and more.
Coverage and Integration condenser—storing data such as compatibility, scalability platform support, collaboration with third-party tools, application program interface (API) access, network coverage, plug-in integrations, continuous integration, continuous deployment, continuous delivery, and more.
Risk condenser—storing data such as vulnerability, trends, severity, exploitability, exposure and reach, remediation metrics, compliance metrics, risk scoring, business impact, finance impact, and more.
Performance condenser—storing data such as data collection frequency, processing overhead, data accuracy, detection speed, system impact, false positive, false negatives, execution speed, reliability, and more.
Analytics condenser—storing predictive analytics, anomaly detection, compliance reporting, drift detection configuration, root cause analytics, and more.

In embodiments, the pulse generation module 415 uses machine learning models (e.g., a random forest model and/or a decision tree model) to facilitate and/or perform pulse packet labeling and/or assigning the pulse packet data to an appropriate condenser. In embodiments, the pulse generation module 415 is further configured to determine and/or assign a score for one or more condensers. In such embodiments, the score may be a quantitative score between 1-100. In these embodiments, a higher score may describe a condenser with relatively lower levels of volatility and/or relatively lower levels of use. For example, if an automation condenser holds data describing a cloud application with high time saved, high error resolution, and a high cycle time reduction, the pulse generation module 415 may assign a score of 90 (on a scale of 1-100). In contrast, a lower score may describe a condenser with relatively higher levels of volatility and/or relatively high levels of use. For example, in response to an infrastructure condenser having data describing a cloud application with high CPU usage, high memory usage, and a high request rate, pulse generation module 415 may assign a score of 40 (on a scale of 1-100). In such embodiments, pulse generation module 415 determines and/or assigns a score for the condensers based on the data that the respective condenser holds.

In additional embodiments, the pulse generation module 415 may assign a numerical score within a qualitative metric. For example, a condenser may be assigned a score between 1-100 for a cloud environment affordability, quality, and/or risk. In embodiments, the score may be assigned based on an application affordability, quality, and/or risk. In other words, in response to the pulse generation module 415 determining that a cloud environment has a security condenser with a relatively high score and a risk condenser with a relatively low score, the overall risk score for that cloud environment may be low (i.e., relatively low risk to operate). In such embodiments, the pulse generation module 415 may determine that the security condenser has a high score based on security applications that carry a high overall cost, such that the cost condenser describes high total cost ownership, high maintenance costs, etc., then the same cloud environment may have a low affordability score (i.e., relatively expensive to operate) while also having the relatively low risk score.

In embodiments, the pulse generation module 415 may be further configured to use a sine wave to determine a score collected from several condensers. As used herein, a sine wave describes and/or forms a smooth periodic oscillation that can represent various values over time. In further embodiments, the pulse generation module 415 may create a visual representation that allows for easy interpretation of the overall performance or state of the system by mapping scores collected from one or more condensers, each with a score between 1-100, onto a sine wave. This can be especially useful for observing trends, fluctuations, and/or patterns in the scores. In embodiments, pulse generation module 415 implements a sine wave by normalizing the scores of the condensers to a range suitable for the sine wave and/or to obtain scores that can be compared between condensers. In embodiments, implementing a sine wave may further include calculating an aggregate score based on an average score, a weighted average score, or another method for aggregating scores. The aggregated score is mapped to the sine wave to determine a corresponding angle in radians. In other words, the sine function oscillates between −1 and 1, so pulse generation module 415 may map the normalized aggregate score to an angle, as the angle varies. In accordance with aspects of the present invention, a switching control module 420 is configured to switch the cloud environment from one set of SRE tools to a different set of SRE tools based on a predicted state of the cloud environment (e.g., as determined by pulse generation module 415, above).

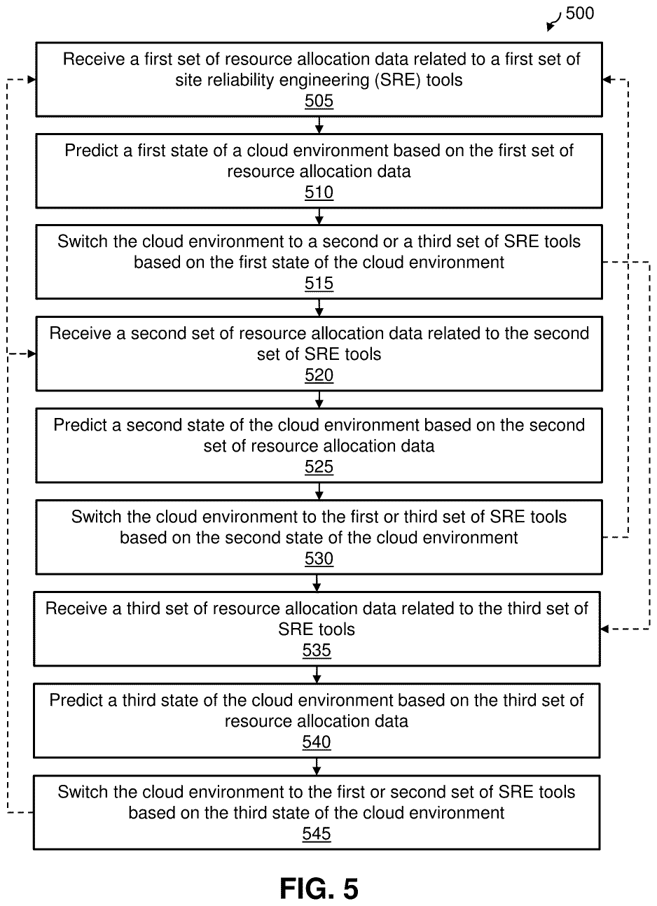

FIG. 5 shows a flowchart of an exemplary method 500 in accordance with aspects of the present invention. Steps of the method may be carried out in the environment of FIG. 4 and are described with reference to elements depicted in FIG. 4.

At step 505, the monitoring and analysis module 410 of FIG. 4 is configured to receive a first set of resource allocation data related to a set of SRE tools. In embodiments, the first set of resource allocation data related to a set of SRE tools may be received by monitoring cloud management applications. In other embodiments, the at least one set of resource allocation data related to a set of SRE tools may be received from (or retrieved at) the cloud management applications. As noted above, SRE tools provide real-time tracking of resources, services, and applications hosted in the cloud. In embodiments, components like virtual machines, containers, databases, storage, and network usage are continuously observed. In embodiments, monitoring may track metrics like resource utilization (e.g., CPU, memory, storage), response times, error rates, and throughput to ensure the cloud infrastructure is operating efficiently. As noted above, in embodiments, the monitoring and analysis module 410 is further, or alternatively, configured to receive and analyze resource allocation data related to Day1 and Day2 Development Operations (DevOps) SRE tools.

At step 510, the pulse generation module 415 of FIG. 4 is configured to predict a first state of a cloud environment based on the resource allocation data received (or alternatively monitored, analyzed, and/or obtained) by the monitoring and analysis module 410 at step 505. In other words, the pulse generation module 415 uses data from the monitoring and analysis module 410 to determine, define, and/or generate a pulse of the system.

At step 515, the switching control module 420 of FIG. 4 is configured to switch the cloud environment from one set of SRE tools to a different set of SRE tools based on a predicted state of the cloud environment. In embodiments, the predicted state of the cloud environment is determined by pulse generation module 415 in step 510. In further embodiments, the switching control module 420 may switch the cloud environment to a second set of SRE tools or a third set of SRE tools based on the first state of the cloud environment. For example, in response to the first set of SRE tools being considered “premium” SRE tools, the second set of SRE tools were considered “hybrid” SRE tools, and the third set of SRE tools were considered “non-premium” SRE tools, switching control module 420 would determine which type of monitoring tool should be used, based on the first state of the cloud environment and a predetermined objective (e.g., cost, efficiency, analytics needs, agility, performance, initial investment, scalability, flexibility, system health, and/or any other objective a company may consider when deploying cloud SRE tools). In embodiments, the premium SRE tools may be used and/or selected for monitoring a relatively volatile cloud environment. In embodiments, the non-premium SRE tools may be used and/or selected for monitoring a relatively stable cloud environment. In embodiments, the hybrid SRE tools may be used and/or selected for monitoring a cloud environment that is neither stable nor volatile.

As used herein, premium SRE tools refer to tools that offer high quality tools for high monetary costs. For example, premium SRE tools may offer advanced capabilities like predictive analytics, artificial intelligence (AI)-driven insights, and customizable dashboards, allowing for proactive identification of potential issues before they impact performance. In embodiments, premium SRE tools may provide seamless integration with a wide range of cloud services, enabling centralized visibility and control across complex, multi-cloud environments. Furthermore, in embodiments, premium SRE tools often include robust support and service level agreements (SLAs), ensuring businesses have expert assistance available whenever critical monitoring or troubleshooting is needed.

As used herein, non-premium SRE tools refer to tools that are not premium SRE tools. An entity (i.e., corporation, cloud management company, etc.) may use non-premium SRE tools due to budget constraints or simpler monitoring needs, as these tools often offer essential functionality at a lower cost. For example, in embodiments, for straightforward cloud environments, non-premium tools may provide sufficient performance tracking and alerts without the need for complex customization or predictive analytics. Furthermore, in embodiments, non-premium tools may have quicker setup times and a lower learning curve. As used herein, hybrid SRE tools comprise SRE tools selected from among the premium SRE tools and non-premium SRE tools.

In embodiments, in response to the predicted state of the cloud environment and/or based on the resource allocation data received indicated that hybrid SRE tools are appropriate, switching control module 420 may switch to the second set of SRE tools. However, in response to the predicted state of the cloud environment and/or based on the resource allocation data received indicated that non-premium SRE tools are appropriate, the switching control module 420 may switch to the third set of SRE tools.

At step 520, the monitoring and analysis module 410 of FIG. 4 is configured to receive a second set of resource allocation data related to a second set of SRE tools. In embodiments, the first and second sets of SRE tools may be the same, meaning the second set of resource allocation data may be received (or alternatively monitored, analyzed, and/or obtained) from the same SRE tools as the first set of resource allocation data. In other embodiments, the first and second sets of SRE tools may be different, meaning the second set of resource allocation data may be received (or alternatively monitored, analyzed, and/or obtained) from different SRE tools as the first set of resource allocation data. In other embodiments, the first and second sets of SRE tools may comprise some of the same SRE tools and some different SRE tools. In other words, some SRE tools may be included in both the first and the second sets of SRE tools.

At step 525, the pulse generation module 415 of FIG. 4 is configured to predict a second state of a cloud environment based on the resource allocation data received (or alternatively monitored, analyzed, and/or obtained) by the monitoring and analysis module 410 at step 520. In embodiments, step 525 may be performed in the same manner as described with respect to step 510 above.

At step 530, the switching control module 420 of FIG. 4 is configured to switch the cloud environment from the second set of SRE tools to a different set of SRE tools based on a predicted state of the cloud environment. For example, in response to the predicted state of the cloud environment and/or based on the resource allocation data received indicated that premium SRE tools are appropriate, the switching control module 420 may switch to the first set of SRE tools. However, in response to the predicted state of the cloud environment and/or based on the resource allocation data received indicated that non-premium SRE tools are appropriate, the switching control module 420 may switch to the third set of SRE tools.

At step 535, the monitoring and analysis module 410 of FIG. 4 is configured to receive a third set of resource allocation data related to a third set of SRE tools. In embodiments, the first, second, and third sets of SRE tools may be different, meaning the third set of resource allocation data may be received (or alternatively monitored, analyzed, and/or obtained) from SRE tools that are different from and/or overlap with some of the second set of SRE tools. In embodiments, the third set of resource allocation data may be received in accordance with steps 505 and 520 above.

At step 540, the pulse generation module 415 of FIG. 4 is configured to predict a third state of a cloud environment based on the resource allocation data received (or alternatively monitored, analyzed, and/or obtained) by the monitoring and analysis module 410 at step 535. In embodiments, step 540 may be performed in the same manner as described with respect to steps 510 and 525 above.

At step 545, the switching control module 420 of FIG. 4 is configured to switch the cloud environment from the third set of SRE tools to a different set of SRE tools based on a predicted state of the cloud environment. For example, in response to the predicted state of the cloud environment and/or based on the resource allocation data received indicated that premium SRE tools are appropriate, the switching control module 420 may switch to the first set of SRE tools. However, in response to the predicted state of the cloud environment and/or based on the resource allocation data received indicated that hybrid SRE tools are appropriate, the switching control module 420 may switch to the third set of SRE tools.

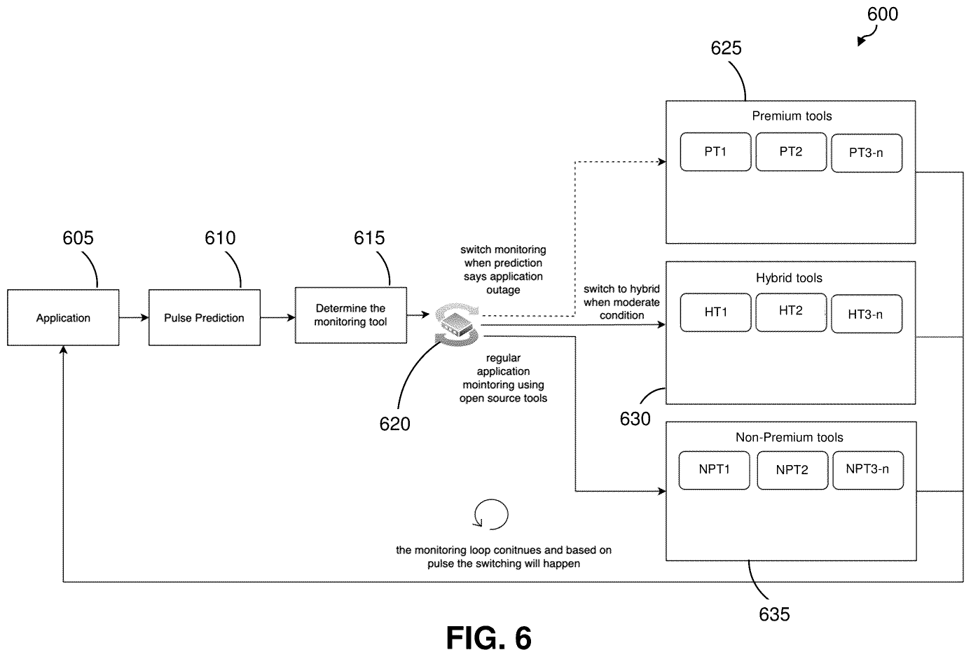

FIG. 6 shows a flow diagram of exemplary method 600 in accordance with aspects of the present invention. Steps of the method may be carried out in the environment of FIG. 4 and may include one or more steps, as described with respect to method 500 of FIG. 5. For example, application 605 (e.g., one or more implementations of monitoring and analysis module 410 of FIG. 4) is used to obtain and/or receive, monitor, and analyze resource allocation data related to SRE tools used in one or more applications operating within a cloud management system. In other words, application 605 monitors and analyzes cloud management applications using a variety of tools and techniques to ensure optimal performance, security, and efficiency. As explained above, monitoring involves real-time tracking of resources, services, and applications hosted in the cloud. In embodiments, components like virtual machines, containers, databases, storage, and network usage are continuously observed. In embodiments, the monitoring and analysis module 410 may monitor and track metrics like resource utilization (e.g., CPU, memory, storage), response times, error rates, and throughput to ensure the cloud infrastructure is operating efficiently. In embodiments, the application 605 monitors and analyzes cloud management applications in accordance with steps 505, 520 and 535 of FIG. 5.

As illustrated, the data from application 605 is fed to block 610 (e.g., one or more instances of pulse generation module 415 of FIG. 4) for pulse prediction. In embodiments, block 610 predicts a state of a cloud environment based on the resource allocation data monitored, analyzed, received, and/or obtained by application 605. In embodiments, block 610 uses data from application 605 to determine, define, and/or generate a pulse of the system. In embodiments, the block 610 predicts the pulse in accordance with steps 510, 525, and 540 of FIG. 5.

The predicted state of the cloud environment is passed to block 615 (e.g., one or more instances of switching control module 420 of FIG. 4) to determine the monitoring tool. In other words, the block 615 is configured to switch the cloud environment from one set of SRE tools to a different set of SRE tools based on a predicted state of the cloud environment. In embodiments, the block 615 determines the SRE tools in accordance with steps 515, 530, and 545 of FIG. 5.

Responsive to the determined SRE tools at block 615, the switch 620 is configured to switch the cloud environment to a premium set of SRE tools 625 (e.g., when the pulse prediction indicates an application outage), a hybrid set of SRE tools 630 (e.g., when the state of the cloud environment is a moderate condition), or a non-premium set of SRE tools 635 (e.g., when engaging in regular application monitoring using open-source tools). As illustrated, method 600 operates on a constant monitoring loop and switches monitoring tool sets based on the pulse of the system. In embodiments, the monitoring loop continues in accordance with steps 505-545 of FIG. 5.

While FIG. 6 shows three sets of SRE tools (e.g., premium set of SRE tools 625, hybrid set of SRE tools 630, and a non-premium set of SRE tools 635), some embodiments may only use two sets of SRE tools. In other embodiments four or more sets of SRE tools may be used, and in such embodiments, switch 620 may be configured to switch between the four or more sets based on the methods described herein.

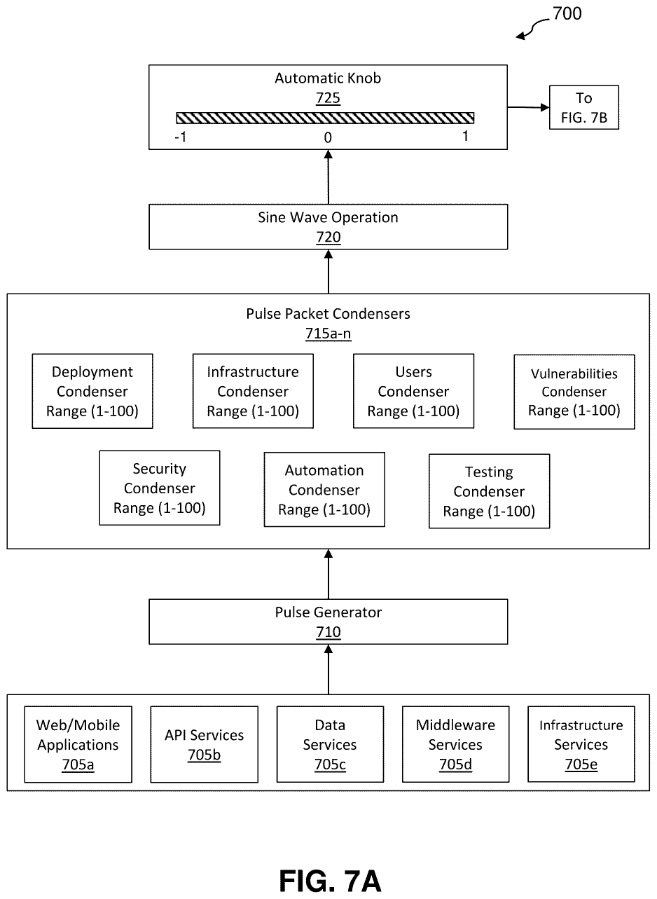

FIGS. 7A-7B show exemplary flow diagram of exemplary environment 700 in accordance with aspects of the present invention. Steps of the method may be carried out in the environment of FIG. 4 and are described with reference to elements depicted in FIG. 4 and may include one or more steps, as described with respect to method 500 of FIG. 5.

As illustrated in FIG. 7A, the environment 700 includes several services (e.g., one or more instances of monitoring and analysis module 410) including web and/or mobile applications 705a, application program interface (API) services 705b, data services 705c, middleware services705d, infrastructure services 705e, etc. In embodiments, these monitoring and analysis module 410 may be configured to monitor and analyze application deployment patterns (e.g., blue-green deployment, canary deployment, rolling deployment, etc.), application infrastructure (e.g., container orchestration, Kubernetes, serverless computing, content delivery network, etc.), an application currently load (e.g., CPU utilization, memory utilization, request rate, database connection pool usage, etc.), a minimum and/or maximum load capacity, number of active users on an application, vulnerability exposure and security issues (cloud security posture management, container and application scanning, web application firewall, threat intelligence, etc.), replicas and states (e.g., Kubernetes, auto scaling groups, various application services, etc.).

The monitoring and analysis data may be gathered by the pulse generator 710 (e.g., one or more instances of pulse generation module 415 of FIG. 4). In embodiments, the pulse generator 710 is configured to generate pulse packets that comprise data related to a state of a cloud environment based on the resource allocation data monitored, analyzed, received, and/or obtained through the monitoring and analysis data.

In accordance with aspects of the instant invention, the pulse packets may be processed provided to pulse packet condensers 715a-n. In embodiments, pulse packet condensers 715a-n may include:
Deployment condenser—storing data such as frequency, success rate, change failure rate, lead time, deployment time, rollback time, uptime, availability, error rates, user impact, mean time to repair (MTTR), and more.
Infrastructure condenser—storing data such as CPU usage, memory usage, disk input/output, network throughput, latency, error rate, request rate, data base performance, cache performance, service health, load balancing, health logs, security metrics, and more.
User Condenser—storing data such as user engagement, retention, conversion rate, error rate, response time, user feedback, feature usage, crash analysis, user-journey analysis, synthetic live experience, and more.
Vulnerability condenser—storing data such as number of vulnerabilities, severity, time to detect, time to remediate, reoccurrence rate, density, patch management, exploitable rate, impact metrics, compliance metrics, and more.
Security condenser—storing data such as mean time to detect, mean time to respond, alert volume, triage rate, closure rate, unauthorized access attempt, authentication success rate, compliance and audit finding, phishing and social engineering metrics, and more.
Automation condenser—storing data such as time saved, error reduction, cycle time reduction, resource utilization, process compliance, throughput and scalability, customer satisfaction, return of investment, operational visibility, and more.
Testing condenser—storing data such as test coverage, detect density, environment stability, stability, resource utilization, throughput, stability, and more.

In embodiments, and as described above with respect to the pulse generation module 415 of FIG. 4, a score may be determined or assigned for one, or more, or all condensers. In such embodiments, the score may be a quantitative score between 1-100. In such embodiments, a higher score may describe a condenser with relatively lower levels of volatility and/or relatively lower levels of use. For example, in response to an automation condenser holding data describing a cloud application with high time saved, high error resolution, and a high cycle time reduction, the pulse generation module 415 may assign a score of 90 (on a scale of 1-100). Whereas a lower score may describe a condenser with relatively higher levels of volatility and/or relatively high levels of use. For example, in response to an infrastructure condenser that has data describing a cloud application with high CPU usage, high memory usage, and a high request rate, the pulse generation module 415 may assign a score of 40 (on a scale of 1-100). In such embodiments, the pulse generation module 415 determines and/or assigns a score for the condensers based on the data that the respective condenser holds.

The determined scores may be passed to a sine wave operation 720. In embodiments, the sine wave operation 720 processes the scores assigned to each condenser, using the scores to create a sinusoidal wave that maps fluctuations in condenser stability or volatility. This wave helps visualize and track performance changes over time, with peaks representing stability (higher scores) and troughs indicating volatility (lower scores). The sine wave operation 720 may also allow for identifying cyclical trends in condenser usage or efficiency by analyzing periodic increases or decreases in scores. Ultimately, the wave pattern serves as a diagnostic tool to help pinpoint and anticipate areas of high use or instability across cloud applications. The sine wave operation 720 further determines the position of the automatic knob. In other words, as the sine wave determines a value between −1 and 1, the knob adjusts to match the sine wave function tracking the stability (and/or volatility) of the system.

In embodiments, to compute the normalized value between −1 and 1, the system (e.g., one or more instances of pulse generation module 415 of FIG. 4) may use the following formula for linear normalization:

$$Normalized Value = ( \frac{( Test Coverage - Old Min ) \times ( New Max - New Min )}{( Old Max - Old Min )} ) + New Min$$

In the formula above, the Old Min (0% test coverage) is equal to 0, the Old Max (100% test coverage) is equal to one hundred, the New Min (normalized) is equal to −1, and the New Max (normalized) is equal to 1. For example, in a first scenario where the test coverage is 15% and the non-coverage is 85%, the calculated normalized value would be 0.7. In a second scenario where the test coverage is 90% and the non-coverage is 10%, the calculated normalized value would be −0.8.

As illustrated in FIG. 7B, the environment 700 includes the Day1 and Day2 Development Operations (DevOps) tools 730 (e.g., one or more instances of monitoring and analysis module 410) to obtain, receive, monitor, and/or analyze resource allocation data related to DDD SRE tools. As provided above, the DDD SRE tools may include tools designed for: performance monitoring (e.g., real-time application monitoring, CPU utilization, memory utilization, network latency, throughput, etc.), security assessment (cloud security posture management, container and application scanning, web application firewall, threat intelligence, etc.), configuration management (e.g., infrastructure as code, configurations in cloud-native services, etc.), log management (e.g., centralized log collection, distributed tracing, log aggregation, etc.), capacity planning (e.g., web application scaling, database provisioning, serverless function management, etc.), backup and recovery (e.g., snapshot backups, object storage backups, database backups, etc.), compliance and auditing (i.e., ensuring that applications meet regulatory requirements and maintain security standards), service management (e.g., service management, change management, service-level management, etc.), end-user experience monitoring (e.g., real-user monitoring, synthetic monitoring, application performance monitoring, etc.), asset management (e.g., cloud resource inventory management, cost management and optimization, compliance management, etc.), network analysis and diagnosis, etc.

The DDD monitoring data is sent to the pulse generator 735 component. In embodiments, the pulse generator 735 is configured to generate pulse packets that comprise data related to the monitored, analyzed, received, and/or obtained DDD data. In accordance with aspects of the instant invention, the pulse packets may be processed and provided to pulse packet condensers 740a-n. As noted above, in embodiments, the pulse packet condensers 740a-n may include:
Functionality condenser—storing data such as comprehensive monitoring data, real-time monitoring data, historical analysis, version control automation log ingestion rate, query language, real-time search, and more.
Scalability condenser—storing data such as capacity, elasticity, data handling, and more.
Ease of Use condenser—storing data such as user interface setup, configurations, reporting, deployment, management and maintenance learning curve, and more.
Alerts/Detection condenser—storing data such as customizable alerts, multichannel notification, escalation policies, alert prioritization, threat detection, zero-day detection, alerts accuracy, and more.
Security condenser—storing data such as data security, access controls, compliance, threat intelligence, encryption, and more.
Cost condenser—storing data such as total-cost ownership, maintenance cost, pricing model, cost efficiency, value for the money enterprise support, initial cost, scalability of cost, operational cost, flexibility and customization cost, hidden cost, and more.
Coverage and Integration condenser—storing data such as compatibility, scalability platform support, collaboration with third-party tools, application program interface (API) access, network coverage, plug-in integrations, continuous integration, continuous deployment, continuous delivery, and more.
Risk condenser—storing data such as vulnerability, trends, severity, exploitability, exposure and reach, remediation metrics, compliance metrics, risk scoring, business impact, finance impact, and more.
Performance condenser—storing data such as data collection frequency, processing overhead, data accuracy, detection speed, system impact, false positive, false negatives, execution speed, reliability, and more.
Analytics condenser—storing predictive analytics, anomaly detection, compliance reporting, drift detection configuration, root cause analytics, and more.

In additional embodiments, a numerical score is within a qualitative metric. For example, a condenser may be assigned a score between 1-100 for a cloud environment affordability, quality, and/or risk. In embodiments, the score may be assigned based on an application's affordability, quality, and/or risk. In other words, in response to the pulse generator 735 determining that a cloud environment has a security condenser with a relatively high score and a risk condenser with a relatively low score, the overall risk score for that cloud environment may be low (i.e., relatively low risk to operate). In such embodiments, it may be determined that the security condenser has a high score based on security applications that carry a high overall cost, such that the cost condenser describes high total cost ownership, high maintenance costs, etc. The same cloud environment may have a low affordability score (i.e., relatively expensive to operate) while also having a relatively low risk score.

In embodiments, the metrics for affordability, quality, and/or risk may be weighted, i.e., one of the metrics may have more weight to influence the combined score. For example, in response to an objective such as quality (e.g., a level(s) of premium), a higher weight may be given to the quality metric of the score. Furthermore, the metrics may be determined using measurable features. For example, for the affordability metric, the system may determine that a cost less than $100 is a low cost, costs between $100-$500 is a medium cost, and costs above $500 is a high cost. The quality metric may be determined by counting the number of features offered by a specific service or by a set of tools.

Measurement metrics 745 operation takes in data processed by the pulse generator 735 by assigning comprehensive scores across key qualitative metrics like affordability, quality, and risk for cloud environments. Pulse packet condensers 740a-n provide specific scores that reflect different aspects of the cloud environment operational performance. For instance, a high score in the risk condenser indicates a low risk, while a low score in affordability signifies high operational costs. Measurement metrics 745 aggregates these individual scores to create an overall profile, allowing a holistic evaluation of the cloud environment. This operation enables the system (or alternatively a user) to quickly assess trade-offs, such as a high-quality environment with high costs but low risk. By quantifying these metrics, measurement metrics 745 quantifies resource allocation, cost optimization, and risk management, to determine a tools pulse knob 750 value between −1 and 1.

In embodiments, the measurement metrics 745 measures the generated pulse in real time. In other embodiments, the measurement metrics 745 measures the pulse based on detecting a new parameter or a new configuration. For example, in response to one of Day1 and Day2 Development Operations (DevOps) tools (DDT tools) 730 being updated or operates under a new version of the tool, the measurement metrics 745 measures and updates the pulse. In embodiments, measurement metrics 745 may use a machine learning model (e.g., a reinforcement learning model) to detect and carry out real-time updates on DDT tools 730 and to update the pulse based on updated DDT tools 730.

In embodiments, the system uses the automatic knob 725 value and/or the tools pulse knob 750 to predict a state of the cloud environment (in accordance with steps 510, 525, and 540 of FIG. 5) and to switch the cloud environment to an appropriate set of SRE tools based on the predicted state of the cloud environment (in accordance with steps 515, 530, and 545 of FIG. 5).

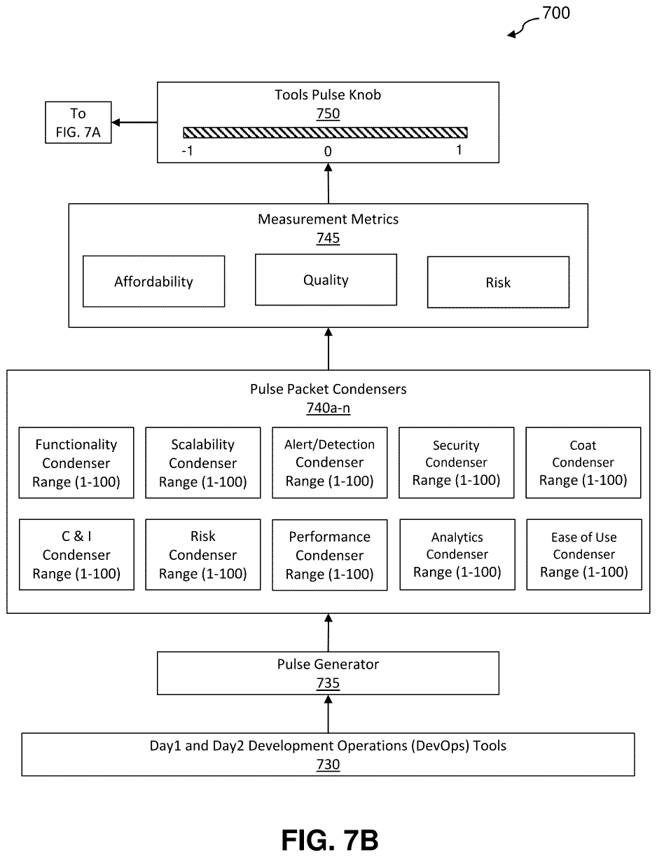

FIG. 8 shows an exemplary sine wave 800 in accordance with aspects of the present invention. Steps of the method may be carried out in portions of environment 400 of FIG. 4 and/or portions of environment 700 of FIGS. 7A-7B and may include one or more steps, as described with respect to method 500 of FIG. 5 and method 600 of FIG. 6. As illustrated, in embodiments, sine wave 800 may define non-premium zone 805, hybrid zones 810, and premium zone 815.

In embodiments, a pulse generator (e.g., one or more instances of pulse generation module 415 of FIG. 4 and/or pulse generator 710 of FIG. 7A) may use a sine wave to determine a score collected from several condensers. As illustrated in FIG. 8, a sine wave describes and/or forms a smooth periodic oscillation that can represent various values over time. By mapping scores collected from one or more condensers, each with a score between 1-100, onto a sine wave, the system (e.g., one or more instances of pulse generation module 415 of FIG. 4) creates a visual representation that allows for easy interpretation of the overall performance or state of the system. In embodiments, implementing a sine wave may further include calculating an aggregate score based on an average score, a weighted average score, or another method for aggregating scores. The aggregated score is mapped to the sine wave to determine a corresponding angle in radians. In other words, the sine wave 800 oscillates between −1 and 1 and a normalized aggregate score may be mapped to an angle, as the angle varies. In embodiments, to compute the normalized value between −1 and 1, the system (e.g., one or more instances of pulse generation module 415 of FIG. 4) may use the following formula for linear normalization:

$$Normalized Value = ( \frac{( Test Coverage - Old Min ) \times ( New Max - New Min )}{( Old Max - Old Min )} ) + New Min$$

In the formula, the Old Min (0% test coverage) is equal to 0, the Old Max (100% test coverage) is equal to one hundred, the New Min (normalized) is equal to −1, and the New Max (normalized) is equal to 1. For example, as illustrated by point 820a in FIG. 8, in a first scenario where the test coverage is 15% and the non-coverage is 85%, the calculated normalized value would be 0.7, as illustrated by point 820a in FIG. 8. In a second scenario where the test coverage is 90% and the non-coverage is 10%, the calculated normalized value would be −0.8.

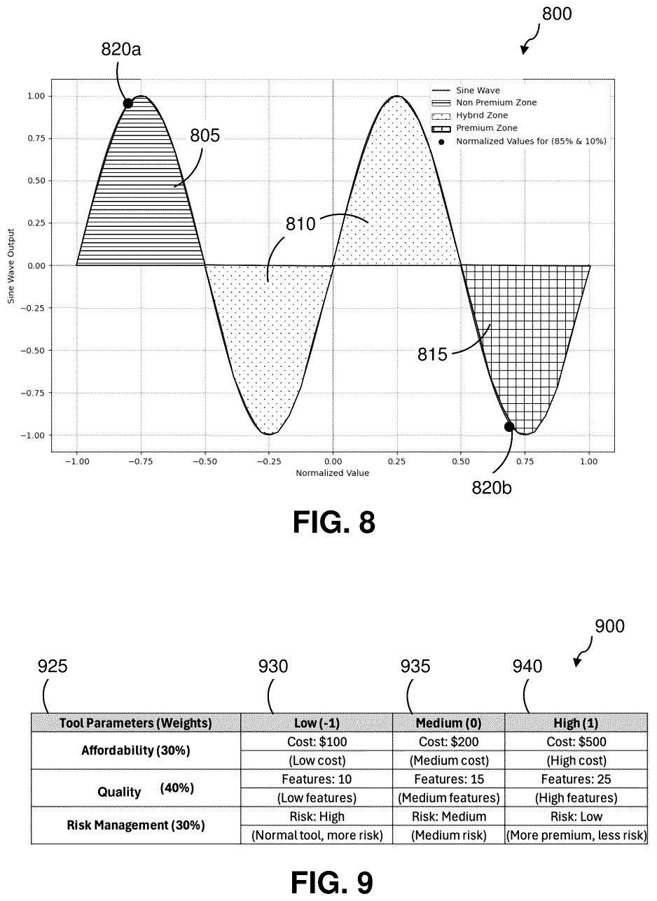

FIG. 9 shows an exemplary calculation table 900 in accordance with aspects of the present invention. Steps of the method may be carried out in portions of environment 400 of FIG. 4 and/or portions of environment 700 of FIGS. 7A-B and may include one or more steps, as described with respect to method 500 of FIG. 5 and method 600 of FIG. 6. As illustrated, in embodiments, table 900 may define tool parameters and weights 925, low category 930, medium category 935, and high category 940.

As illustrated, the system may use the table to determine scores for a cloud monitoring tool or a combination of site reliability engineering (SRE) tools (e.g., cloud monitoring tools). For example, in embodiments, an affordability may be given a 30% weighting for calculating a total score. Tools or combinations of tools me be given a score within low category 930 when the cost is less than $100; a score within medium category 935 when the cost is between $100-$500; and a score within high category 940 when the cost is greater than $500. In an exemplary scenario, a combination of SRE tools may cost $650, includes 25 features, and is low risk. To determine the affordability score, for example, the 30% weighting is multiplied by the table score. Thus, the affordability score would be 0.3 (1*0.3). The same applies for quality (1*0.4) and risk management (1*0.3). The total score is found by adding each of the scores (0.3+0.4+0.3). The total score of 1 indicates that this tool falls into a “premium” category based on the weights assigned. Adjusting the parameters (e.g., changing affordability, quality, and/or risk level) would yield different scores. Furthermore, the tools may be classified using other tools and/or options based on their combined attributes.

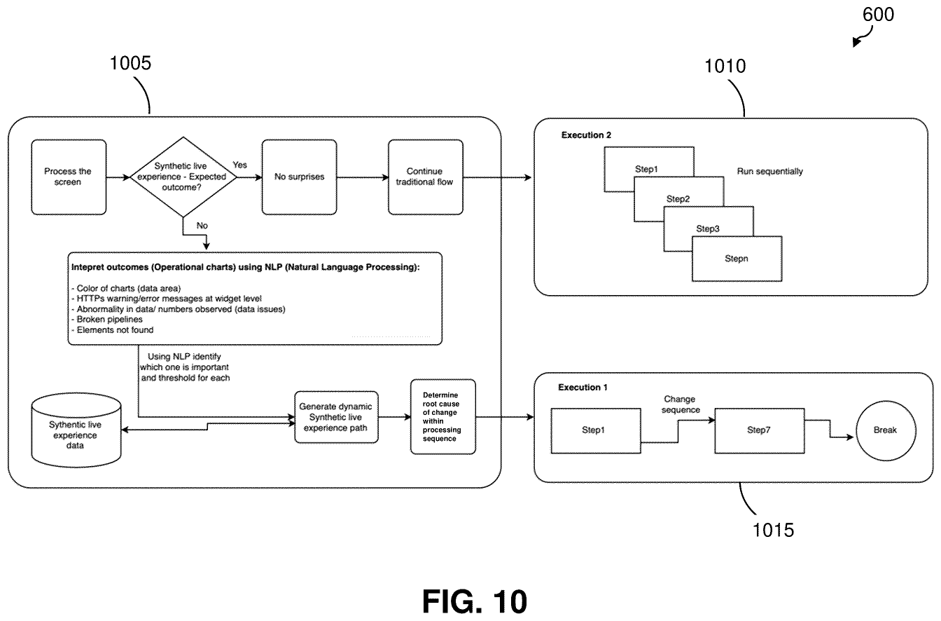

FIG. 10 shows an exemplary method 1000 in accordance with aspects of the present invention. Steps of the method may be carried out in portions of environment 400 of FIG. 4 and/or portions of environment 700 of FIGS. 7A-B and may include one or more steps, as described with respect to method 500 of FIG. 5 and method 600 of FIG. 6. As illustrated synthetic live experience module 1005 (e.g., one or more instances of pulse-based management server 405) receives, obtains, and/or monitors data that is being displayed on a user's dashboard. Synthetic live experience module 1005 may perform a synthetic live experience on the data that is being displayed on a user's dashboard screen. As used herein, a synthetic live experience refers to simulations that mimic real user interactions to monitor and assess the performance and reliability of cloud-based applications and services. Unlike relying solely on actual user data or passive monitoring, synthetic monitoring proactively tests cloud services by creating simulated transactions or actions. This approach is valuable because it allows teams to stay ahead of performance issues by simulating different scenarios before they occur.

When the synthetic live experience returns an expected outcome and there are no surprises, the synthetic live experience module 1005 continues the traditional flow of data processing and monitoring module 1010, where the steps are performed according to a sequential schedule. When the synthetic live experience returns an unexpected outcome, synthetic live experience module 1005 interprets the outcomes (e.g., operational charts) using natural language processing (NLP) models. In embodiments, the NLP models will detect and/or apply colors to specific areas of operational charts, detect and/or generate warning and error messages at a widget level, detect abnormalities in the observed data, detect broken data pipelines, and detect elements that are expected but are not found, and more. In embodiments, the NLPs for performing this functionality may include text classification models (e.g., Bidirectional Encoder Representations from Transformers (BERT), Robustly Optimized BERT Pretraining Approach (ROBERTa), and/or Generative Pre-trained Transformer (GPT)), entity recognition and abnormality detection models (e.g., named entity recognition (NER)), computer vision integration models (e.g., optical character recognition and/or image segmentation), and more.

In embodiments, the synthetic live experience module 1005 may further determine data that is more important (i.e., data that has a relatively larger impact on the outcome of the synthetic live experience) using the NLP model results. In other words, using the NLP identification, the synthetic live experience module 1005 may interpret and compare the results against a threshold to determine which data has a greater impact on the outcome of the synthetic live experience. The synthetic live experience module 1005 uses the identified data to generate a dynamic live experience path, meaning, a sequence of interactions or events that can change based on user behavior, preferences, or external data inputs in real time to tailor the synthetic experience to be more immersive and responsive, based on the data identified by the NLP model. In embodiments, the synthetic live experience module 1005 stores the synthetic live experience data as a corpus for future machine learning training and for future processing decisions.

In embodiments, the synthetic live experience module 1005 may analyze the dynamic live experience path and/or the data identified by the NLP model to determine one or more processing sequence steps that are the root cause of the unexpected changes within the sequence. In other words, the synthetic live experience module 1005 determines the root cause of the changes that cause the unexpected outcomes in the synthetic live experience.

The synthetic live experience module 1005 breaks the traditional sequence of processing by changing the sequence in data processing and monitoring module 1015. Instead, the synthetic live experience module 1005 processes and/or executes the steps that are needed, even if it is out of sequence. For example, in response to the synthetic live experience module 1005 detecting that processing steps 2 through 6 are identified as problematic (i.e., because they are redundant or because they cause the unexpected outcome during the synthetic live experience), the data processing and monitoring module 1015 skips processing steps 2-6 and moves straight to processing step 7, as illustrated in FIG. 10.

In embodiments, a service provider could offer to perform the processes described herein. In this case, the service provider can create, maintain, deploy, support, etc., the computer infrastructure that performs the process steps of the present invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the present invention provides a computer-implemented method, via a network. In this case, a computer infrastructure, such as computer system/server 12 (FIG. 1), can be provided and one or more systems for performing the processes of the present invention can be obtained (e.g., created, purchased, used, modified, etc.) and deployed to the computer infrastructure. To this extent, the deployment of a system can comprise one or more of: (1) installing program code on a computing device, such as computer system/server 12 (as shown in FIG. 1), from a computer-readable medium; (2) adding one or more computing devices to the computer infrastructure; and (3) incorporating and/or modifying one or more existing systems of the computer infrastructure to enable the computer infrastructure to perform the processes of the present invention.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving, by a processor set, a first set of resource allocation data related to a first set of site reliability engineering (SRE) tools;
predicting, by the processor set, a first state of a cloud environment based on the first set of resource allocation data, wherein the first state and the first set of resource allocation data describe a stable cloud environment;
switching, by the processor set, the cloud environment to a second set of SRE tools based on the first state of the cloud environment, wherein the second set of SRE tools are selected for monitoring the stable cloud environment;
receiving, by the processor set, a second set of resource allocation data related to the second set of SRE tools;
predicting, by the processor set, a second state of the cloud environment based on the second set of resource allocation data, wherein the second state and the second set of resource allocation data describe a volatile cloud environment; and
switching, by the processor set, the cloud environment to the first set of SRE tools based on the second state of the cloud environment, wherein the first set of SRE tools are selected for monitoring the volatile cloud environment.

2. The computer-implemented method of claim 1, further comprising providing a report describing the first state of the cloud environment and the second state of the cloud environment.

3. The computer-implemented method of claim 1, wherein the prediction based on the second set of resource allocation data is performed using a machine learning model and comprises a first prediction that the first set of SRE tools will meet a first resource performance threshold.

4. The computer-implemented method of claim 1, wherein the prediction based on the first set of resource allocation data is performed using a machine learning model and comprises a second prediction that the second set SRE tools will meet a second resource performance threshold.

5. The computer-implemented method of claim 1, further comprising:
receiving a third set of resource allocation data related to a third set of SRE tools;
predicting a third state of the cloud environment based on the third set of resource allocation data; and
switching the cloud environment to a third set of SRE tools based on the third state of the cloud environment.

6. The computer-implemented method of claim 5, wherein the prediction based on the third set of resource allocation data comprises a third prediction that the third set of SRE tools will meet a third resource performance threshold.

7. The computer-implemented method of claim 5, wherein the first set of SRE tools comprises premium SRE tools,
the second set of SRE tools comprises non-premium SRE tools, and
the third set of SRE tools comprises hybrid SRE tools.

8. The computer-implemented method of claim 5, wherein the first state of the cloud environment, the second state of the cloud environment, and the third state of the cloud environment are mapped to a pulse packet sine curve.

9. The computer-implemented method of claim 5, wherein the first state of the cloud environment correlates to a first integral of a pulse packet sine curve, the second state of the cloud environment correlates to a second integral of the pulse packet sine curve, and the third state of the cloud environment correlates to a third integral of the pulse packet sine curve.

10. A computer program product comprising one or more computer readable storage media having program instructions collectively stored on the one or more computer readable storage media, the program instructions executable to:
receive a first set of resource allocation data related to a first set of site reliability engineering (SRE) tools;
predict a first state of a cloud environment based on the first set of resource allocation data, wherein the first state and the first set of resource allocation data describe a stable cloud environment;
switch the cloud environment to a second set of SRE tools based on the first state of the cloud environment, wherein the second set of SRE tools are selected for monitoring the stable cloud environment;
receive a second set of resource allocation data related to the second set of SRE tools;
predict a second state of the cloud environment based on the second set of resource allocation data, wherein the second state and the second set of resource allocation data describe a volatile cloud environment; and
switch the cloud environment to the first set of SRE tools based on the second state of the cloud environment, wherein the first set of SRE tools are selected for monitoring the volatile cloud environment.

11. The computer program product of claim 10, wherein the program instructions are further executable to provide a report describing the first state of the cloud environment and the second state of the cloud environment.

12. The computer program product of claim 10, wherein the prediction based on the second set of resource allocation data is performed using a machine learning model and comprises a first prediction that the first set of SRE tools will meet a first resource performance threshold, and the prediction based on the first set of resource allocation data is performed using the machine learning model and comprises a second prediction that the second set SRE tools will meet a second resource performance threshold.

13. The computer program product of claim 10, wherein the first set of SRE tools comprises premium SRE tools, and the second set of SRE tools comprises non-premium SRE tools.

14. The computer program product of claim 10, wherein the program instructions are further executable to:
receive a third set of resource allocation data related to a third set of SRE tools;
predict a third state of the cloud environment based on the third set of resource allocation data; and
switch the cloud environment to a third set of SRE tools based on the third state of the cloud environment.

15. The computer program product of claim 14, wherein the first state of the cloud environment correlates to a first integral of a pulse packet sine curve, the second state of the cloud environment correlates to a second integral of the pulse packet sine curve, and the third state of the cloud environment correlates to a third integral of the pulse packet sine curve.

16. A system comprising:
a processor, a computer readable memory, one or more computer readable storage media, and program instructions collectively stored on the one or more computer readable storage media, the program instructions executable to:
receive a first set of resource allocation data related to a first set of site reliability engineering (SRE) tools;
predict a first state of a cloud environment based on the first set of resource allocation data, wherein the first state and the first set of resource allocation data describe a stable cloud environment;
switch the cloud environment to a second set of SRE tools based on the first state of the cloud environment, wherein the second set of SRE tools are selected for monitoring the stable cloud environment;
receive a second set of resource allocation data related to the second set of SRE tools;
predict a second state of the cloud environment based on the second set of resource allocation data, wherein the second state and the second set of resource allocation data describe a volatile cloud environment; and
switch the cloud environment to the first set of SRE tools based on the second state of the cloud environment, wherein the first set of SRE tools are selected for monitoring the volatile cloud environment.

17. The system of claim 16, wherein the program instructions are further executable to provide a report describing the first state of the cloud environment and the second state of the cloud environment.

18. The system of claim 16, wherein the prediction based on the second set of resource allocation data is performed using a machine learning model and comprises a first prediction that the first set of SRE tools will meet a first resource performance threshold, and the prediction based on the first set of resource allocation data is performed using the machine learning model and comprises a second prediction that the second set SRE tools will meet a second resource performance threshold.

19. The system of claim 16, wherein the first set of SRE tools comprises premium SRE tools, and the second set of SRE tools comprises non-premium SRE tools.

20. The system of claim 16, wherein the program instructions are further executable to:
receive a third set of resource allocation data related to a third set of SRE tools;
predict a third state of the cloud environment based on the third set of resource allocation data; and
switch the cloud environment to a third set of SRE tools based on the third state of the cloud environment.
